(19) United States
(12) Patent Application Publication
(10) Pub. No.: US 2012/0095881 A1
(43) Pub. Date: Apr. 19, 2012

(54) ATOMIZING E-COMMERCE

(75) Inventor: Simon Rothman, Palo Alto, CA (US)

(73) Assignee: Glyde Corporation, Palo Alto, CA (US)

(21) Appl. No.: 12/906,013

(22) Filed: Oct. 15, 2010

(51) Int. Cl. G06Q 30/00

(52) U.S. Cl. 705/27.2

(57) ABSTRACT

The present invention provides software system with an ability to atomize e-commerce. The capability of buying and selling a product can be inserted onto any website, even websites that are not directly related to e-commerce. The capability can be pushed out to 3rd party sites, widgets on social networking sites, references in blogs, articles, etc. For example, a reference to a product on a 3rd party website contains a link to buy or sell the product or service, without having to leave the 3rd party website. As used herein, a “reference” can be anything which references a product or service, such as images, text, a widget, etc. In some cases, a reference can be referred to as an “ad.”

### BACKGROUND OF THE INVENTION

The present invention relates to buying and selling products on the Internet, and in particular to simplifying the user experience.

When purchasing goods, most websites follow a model popularized by Amazon.com and others. The user first selects the product on a product webpage, then must navigate through the checkout pages on separate web pages. Similarly, when selling goods, a user may create a website or go to a website such as eBay.com to list his product for sale.

Currently the Internet experience mirrors the physical. In the brick and mortar world, a user walks from storefront to storefront to buy goods. On the Internet, a user navigates from website to website. Some websites are like shopping malls, with users able to go to one commerce destination site, but then navigating from page to page to choose goods for sale from one or more merchants. When advertising is done on other websites, the user can click on the ad to navigate to the storefront website selling the advertised goods. Once the user is at the storefront, the user first selects the product, then must navigate through the checkout pages. However, the user is typically directed away from the initial website to the storefront, thus the user is acutely aware that he is no longer browsing the initial website.

Ads take many forms on the internet. Typically, a “banner ad” is a rectangular graphic element on a webpage has the artwork and product description, with a hyperlink. If the user clicks on the ad, the user is taken to the website offering the product or service. There are also pop-up ads, ads that incorporate video, pop-under ads and floating ads. These ads typically describe one product or service, or a class of products or services.

With respect to providing information to users, this takes many forms. In addition to web pages, ticker-type information can be provided which scrolls across the bottom of the screen, such as a stock ticker. RSS feeds can provide customized content, such as news subjects the viewer is interested in, pushed to a webpage for viewing.

US Patent Application Publication No. 20030020758 describes providing dynamically alterable banner ads. The ads can scroll either horizontally or vertically.

Unicast Communications Corporation U.S. Pat. No. 7,155,663 describes a number of prior art techniques for providing ads in web pages. A banner ad is generally produced by embedding HTML code for that banner within the HTML coding for a given web page. Consumers can obtain more information by clicking through the ad, thus being referred to the advertiser's site, and click through counts can be monitored. Interstitial ads are displayed in an interval of time that occurs after a user has clicked on a hot-link displayed by a browser to retrieve a desired web page but before that browser has started rendering that page. Ads can also be provided via a “push” application program that connects with a server, typically during off-hours. Ads are downloaded for later display. A user profile is used to determine the type of ads for that user. Real-time downloading and rendering of advertising HTML files uses advertising files stored on remote web servers. These ads show content in a “streamed” media file that relies on a continuous real-time network connection existing to a remote web server.

The '663 patent goes on to describe decoupling referring web page content from its corresponding advertising content, allowing an advertiser to easily update ads. Multi-threaded pipelining is used, processing each ad as a different thread.

US Patent Application Publication No. 20070083440 describes electronic advertising that enables a consumer to purchase advertised products while remaining connected to a hosting website. The banner ads contain links that are activated to send a request to the banner applet for additional product information, or for an order form to allow the consumer to purchase the advertised product. The banner applet supplies on-demand information to the consumer workstations without causing the workstations to query the hosting server, or to terminate or suspend their active sessions with the sessions manager.

### BRIEF SUMMARY OF THE INVENTION

The present invention provides a software system with an ability to atomize e-commerce. The capability of buying and selling a product can be inserted onto any website, even websites that are not directly related to e-commerce. The capability can be pushed out to 3rd party sites, widgets on social networking sites, references in blogs, articles, etc. For example, a reference to a product on a 3rd party website contains a link to buy or sell the product or service, without having to leave the 3rd party website. As used herein, a “reference” can be anything which references a product or service, such as images, text, a widget, etc. In some cases, a reference can be referred to as an “ad.”

There are numerous ways in which the e-commerce capability can be inserted onto a variety of websites. For ease of discussion, sites containing the e-commerce capabilities of embodiments of the present invention will be referred to as 3rd party sites, although this is for purposes of identification and not limitation. A 3rd party site is any site containing embodiments of the present invention. In some embodiments, the operator of the third party site will insert a code segment onto a web page or pages of the site to enable the atomization of e-commerce. In other embodiments, the 3rd party web server will utilize an Application Programming Interface (API) provided by an e-commerce site to enable the atomizing of e-commerce functionality. In some embodiments, a plug-in on the user's browser or an application running on the 3rd party website server will implement the atomization of e-commerce.

Once e-commerce has been atomized and pushed out to 3rd party websites, a user viewing such a website may be presented with a commerce window capability in which to conduct a buy or sell transaction. All information to conduct the transaction may be presented in the commerce window. In one embodiment, the commerce window is presented as an iframe that is superimposed on top of the 3rd party website. From the perspective of the user, it appears as if the user has never left the 3rd party website. In some embodiments, the commerce window may provide a “white label” view of the e-commerce system, such that the user need not be aware that the e-commerce functionality is being provided by an external e-commerce system. In other embodiments, the commerce window may be branded by the operator of the e-commerce system, in order to promote use of the e-commerce system.

The independent e-commerce system may include data on (1) products, including dimensions and weight, (2) sellers, including location, and (3) the user (if previously registered), including his location and credit card information. For example, when the user first navigates to the 3rd party website, the software already has all the data needed to calculate shipping price for a sale (knowing the product weight, dimensions, and in some cases where it is to be shipped from and to in the case of a purchase), allowing a total price to be displayed on the page. In the case of a sell transaction, the e-commerce system may suggest a listing price based on factors such as the current selling price of the same item, the quantity available, the conditions of those items, and other such market driven factors.

### BRIEF DESCRIPTION OF THE DRAWINGS

FIG. 1 illustrates one embodiment of a 3rd party website that has implemented atomizing of e-commerce.

FIG. 2 depicts the e-commerce buy capability in the open state.

FIG. 3 depicts the e-commerce sell capability in the open state.

FIGS. 4(a-f) depict screen shots of the various screens presented to a user who is purchasing a product using an embodiment of the present invention.

FIGS. 5(a-c) depict screen shots of the various screens presented to a user who is selling a product using an embodiment of the present invention.

FIG. 6 illustrates one embodiment of how commerce can be atomized.

FIG. 7 illustrates a system supporting the present invention.

FIG. 8 is a high level block diagram of a computer system used in embodiments of the invention.

### DETAILED DESCRIPTION OF THE INVENTION

Atomizing E-Commerce

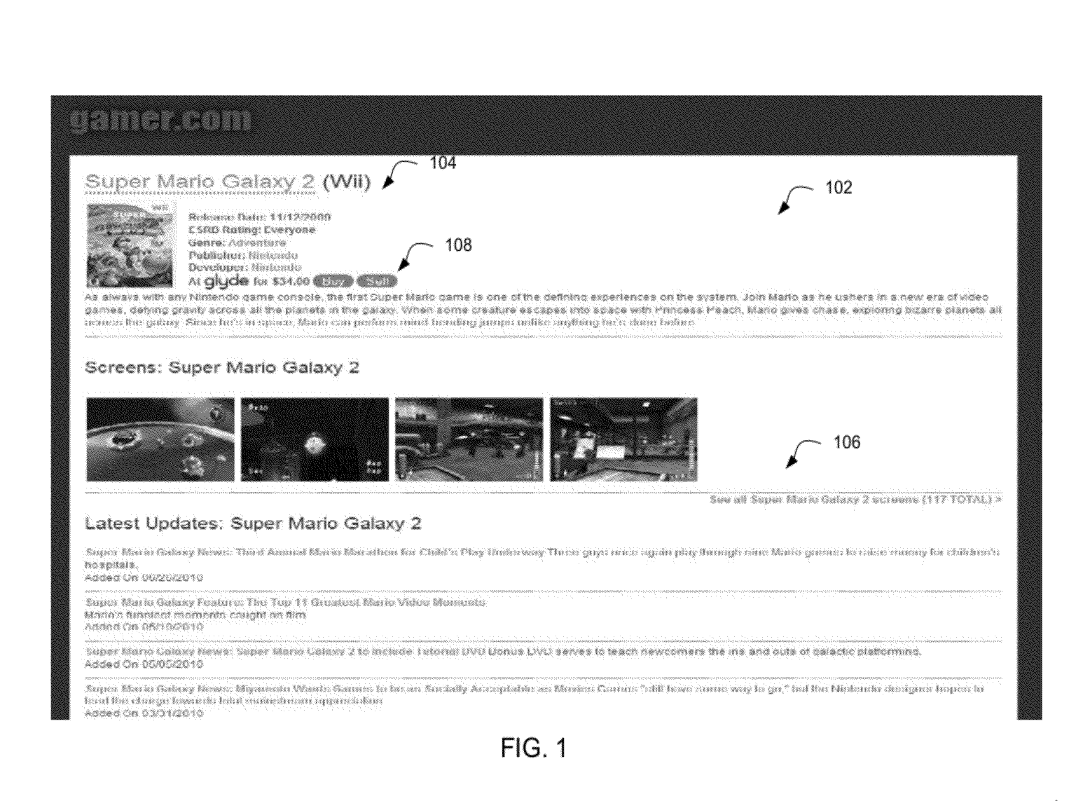

FIG. 1 illustrates one embodiment of a 3rd party website that has implemented atomizing of e-commerce. A page of the 3rd party website 102 provides a review of a particular video game, including information such as the games release date, genre, publisher, and developer 104. Although a video game review is depicted, this is for purposes of explanation only. It should be understood that embodiments of the invention are applicable to any website that references products or services that can be bought or sold. As depicted, the pages of the website can contain additional information 106 such as reviews of the product, blogs discussing the product, general references to the product, or other information. The content of the website described is independent of the ability to buy or sell the product being referenced.

Embodiments of the invention provide the ability to add e-commerce functionality to a website that may not previously have had the capability. Commerce is atomized into a discrete element that may be inserted onto a web page. Through the use of this discrete element, or atom, the full capabilities of e-commerce can implemented on a website with minimal development effort required by the website operator. As shown in FIG. 1, the e-commerce capability 108 can be inserted onto a 3rd party website, with minimal changes to the 3rd party website. The changes required to the 3rd party website will be discussed in further detail below. For now, it should be understood that embodiments of the invention provide the ability for e-commerce 108, that is buying and selling of products and services, to be inserted on a website that may not have previously contained such capabilities. There are many reasons why a 3rd party website would desire to add e-commerce. The addition of e-commerce may make the website more attractive to users, thus increasing traffic. The 3rd party website operator may engage in a revenue sharing model, wherein some portions of the proceeds of transactions are given to the website operator. In some cases, the e-commerce system operator may pay the 3rd party website operator to add e-commerce to his website, in order to increase the use of the e-commerce system.

As shown in FIG. 1, the e-commerce capability 108 is related to the specific product that is being shown on web page 102, however embodiments of the invention are not limited to one product per web page. On web pages that contain references to more than one product, atomized e-commerce related to each of those products is also contemplated.

As depicted in FIG. 1, the atomized e-commerce capability 108 is shown in the “closed” state. In some embodiments, in the closed state the user is presented with a current selling price of the item, a button to click to purchase the item, and a button to click to sell the item. In other embodiments, the atomized e-commerce capability may be presented as a hyperlinked image, text, or any other clickable element on a web page. In general, the closed state refers to any indicia present on the 3rd party website that indicates to a user that the atomized e-commerce capability has been implemented on the website. Although the term click has been used, in some embodiments the user may not actually have to click, but rather may simply hover the pointing indicator, such as a mouse pointer, over the atomized e-commerce representation.

In one embodiment, upon loading of the web page 102, the atomized e-commerce capability 108 may contact an e-commerce system to obtain the latest real time pricing information for the product, which is described further below. The e-commerce system may be an online marketplace where buyers and sellers can purchase, or list for sale, various products or services. The e-commerce system may allow sellers to list products for sale, and provide tools to assist the seller in setting a price for the sale. The price for sale can take into account factors such as the number of items available, the distance from a buyer to the seller (used for calculating shipping costs), recent sale prices for the item, and any number of additional market driven factors. A seller may list his product for sale on the e-commerce system.

Likewise, a buyer may access the e-commerce system to purchase a product or service. The e-commerce system may allow the user to select a product, and will present to the buyer the current price for the item, based on factors such as the condition (new, good, fair) of the item being sold, the shipping price (based on product size/weight and distance to the seller), reputation of the seller, or any number of other factors. The e-commerce system may provide the buyer with the best available price for the item, taking into account the buyer's preferences and location.

It should be understood that the e-commerce system may operate independently of the ability to atomize e-commerce. That is, the e-commerce system itself may be a stand alone website which users may visit to buy and sell goods or services. The e-commerce system may be a system associated with a single vendor that provides the ability to buy or sell products. The e-commerce system may also be a multi-vendor marketplace. The e-commerce system may provide an environment wherein any number of vendors may establish individual store fronts to buy and sell goods. The e-commerce system may also be a multi-vendor marketplace wherein multiple vendors may buy and sell products, however to the end user, the e-commerce system appears as a unified vendor. Embodiments of the invention can advantageously integrate with many different types of e-commerce systems, regardless of the particular commerce model implemented within the e-commerce system.

Embodiments of the present invention provide the ability to push the buying and selling capabilities of the e-commerce system out to 3rd party websites that may not contain such capabilities. This is done in a manner that is advantageous to the 3rd party website operator in that the operator does not need to provide and maintain the e-commerce functionality. Rather, the 3rd party website operator may rely on the capabilities provided by the e-commerce system for buy and sell functionality. Furthermore, because the e-commerce occurs on the 3rd party website, the user does not have to leave the 3rd party website. The 3rd party website operator can still benefit from other economically beneficial activities the user engages in, such as viewing ads. Furthermore, the user need not be aware that the buy or sell transaction is being conducted on the e-commerce system. From the perspective of the user, the transaction takes place entirely on the 3rd party website.

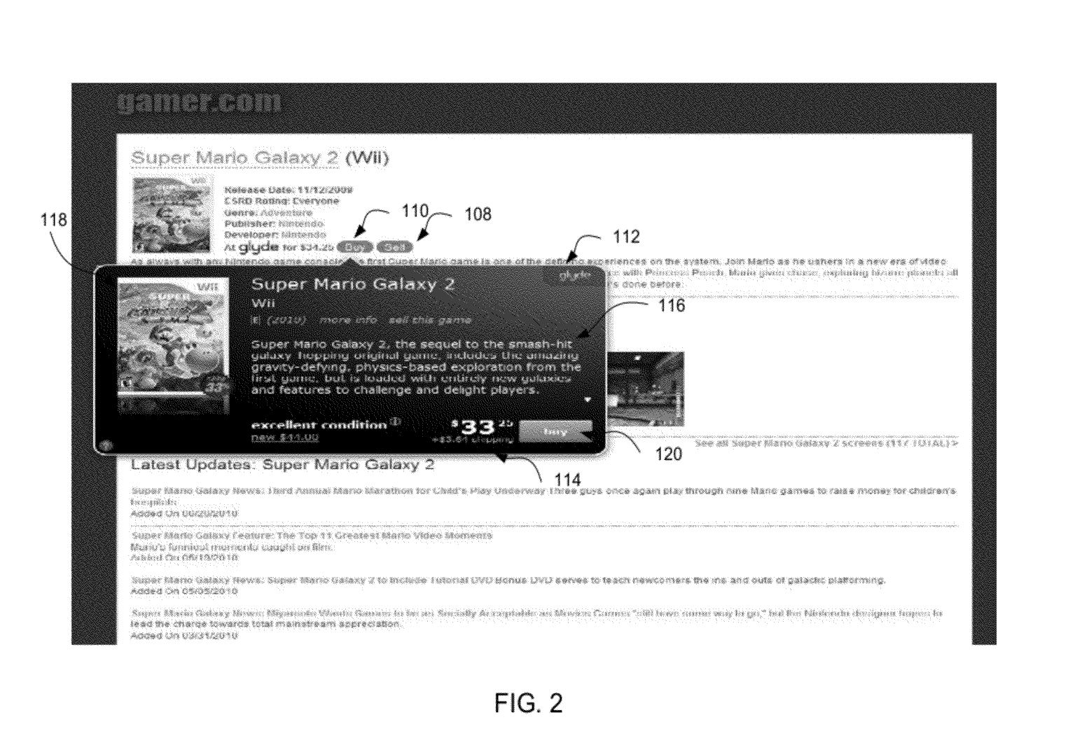

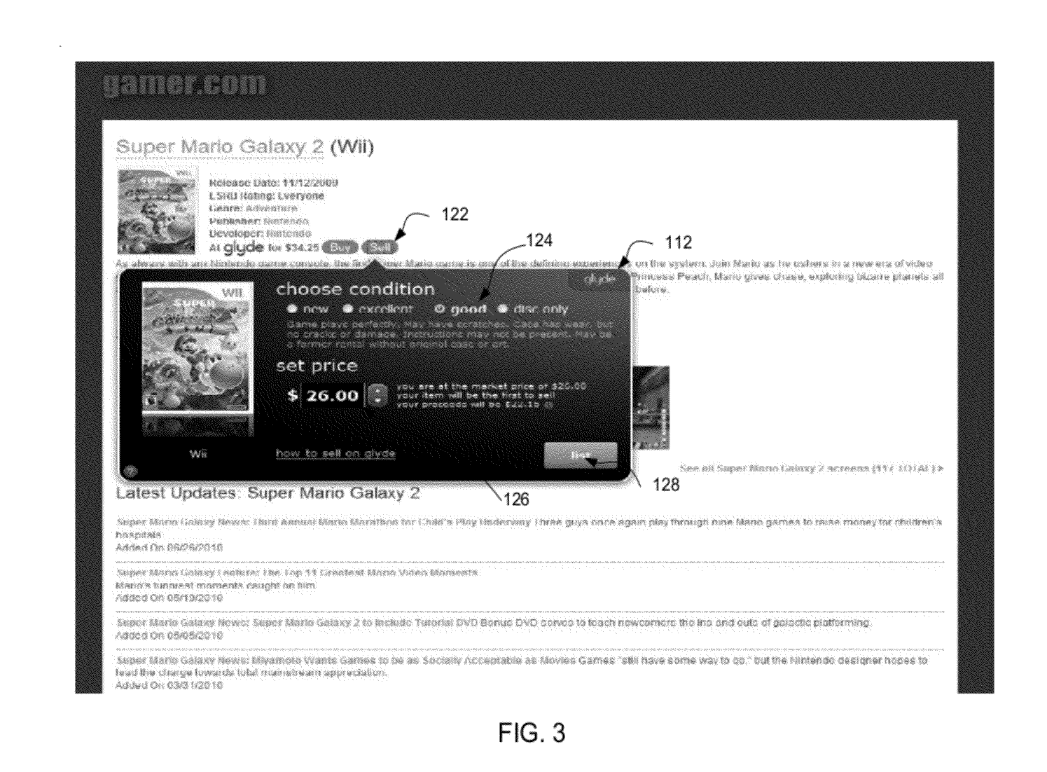

As mentioned above, in one embodiment, upon loading of the web page 102, the atomized e-commerce capability 108 may communicate with the e-commerce system to obtain the latest pricing information for the item of interest on the web page, and display this price to the user. In some embodiments, the current pricing information is periodically updated via polling or push technologies, reflecting the real time price of the item. Thus, even if the user stays on a given web page 102 for an extended period of time, the current price will be updated to reflect the actual real time price. The user may then click on the buy or sell button to initiate a commerce window, which can be also referred to as the “open” state, to buy or sell the item. The open state will be described further with respect to FIGS. 2 and 3.

In one embodiment, the atomized e-commerce capability 108 is inserted onto a 3rd party website through the use of a code segment. For example, the code segment may include Hypertext Markup Language as well as Javascript, the combination of which is often referred to as Dynamic Hypertext Markup Language (DHTML). However, the use of DHTML is merely exemplary. A person of skill in the art would understand that any technology that can provide the functionality described below could also be used. The operator of a 3rd party website may manually identify a product that is on a page of the website. The 3rd party operator then obtains, either by requesting it from the operator of the e-commerce system or through a tool provided by the operator of the e-commerce system, a code segment that is related to the identified product. The product identification may include things such as the Universal Product Code (UPC) of the item, the International Standard Book Number (ISBN) of an item, the name of the item, the title of the item, or any other identifier that uniquely identifies the item. The 3rd party website operator may then insert this code segment onto the web page that references the identified product.

The code segment may include code to insert the atomized e-commerce capability 108 onto the 3rd party website. For example, the code segment may include the buy and sell buttons as depicted in FIG. 1. Furthermore, the code segment may include code that allows the atomized e-commerce capability 108 to communicate with the e-commerce system through the user's web browser to obtain information such as the latest pricing information for display. In addition to pricing information, other information, such as availability and condition (for used products), product images or other data about the product may be provided by the e-commerce system. This other information will be described further with respect to the open state.

The code segment may also be customized to suit the preferences of the operator of the 3rd party website. As mentioned above, the atomized e-commerce capability may be presented in the form of buy/sell buttons, linked images, or linked text, at the option of the 3rd party website operator. Furthermore, the operator can specify if the user must click on the e-commerce capability 108 in order to enter the open state, or if the open state will be entered upon hovering over the e-commerce capability. The 3rd party website operator may also specify the e-commerce capabilities that are desired. For example, the ability for a user to buy products, the ability for a user to sell products, or the ability to both buy and sell products. In addition, the 3rd party website operator can limit access to the e-commerce system to only the specific product being displayed, to products similar to the one being displayed, or to any products available on the e-commerce system.

By way of example, and not limitation, the operator of the 3rd party website depicted in FIG. 1 may determine that a web page contains a reference to a specific product. The operator may then communicate with the e-commerce system, to produce a code segment that is specifically related to the product. As mentioned above, the code segment may be customized based on the preferences of the website operator. The operator then inserts this code segment onto the web page referencing the product.

A user may then use a web browser to access the web page containing the code segment. Upon loading of the page, the code segment may cause the buy and sell buttons to be displayed on the web page. Furthermore, the code segment may open a communications channel to the e-commerce system, via the user's web browser, in order to receive data, such as current pricing information, from the e-commerce system. The received information can then be displayed on the web page. Although current pricing information is described, embodiments of the invention are not so limited. For example, the data may also include how many of the specific product are currently being offered for sale. If a user is in possession of the product, and wishes to sell it, he may utilize the e-commerce system to list the item for sale.

Although the code segment being manually identified and inserted onto a 3rd party website has been described, embodiments of the invention are not so limited. In one embodiment, the code segment may not be related to a specific product, but rather will contain code that will scan a web page to determine any products that are being referenced by that page. The code segment, through the user's browser, may then access the e-commerce system to obtain information about the product or products that are being referenced.

Again, by way of example, and not limitation, a 3rd party website operator may insert a code segment that scans a web page onto the web page. When the web page is loaded by the user's web browser, the code segment may execute to scan the web page for any identifier that could be related to a product. For example, UPC or ISBN numbers, product titles, product descriptions, or free text could all be suitable identifiers. The code segment may open a communications channel with the e-commerce system, and send each identifier determined from scanning the web page to the e-commerce system. The e-commerce system may then determine if the identifier is associated with a product that can be bought or sold on the e-commerce system. If so, the identifier on the web page can be turned into a link, which the user may then use to buy or sell the product.

In such an embodiment, the 3rd party website owner advantageously does not have to obtain and insert code segments individually for each product on each web page of the site, but rather can insert a single, generic code segment into every page. The generic code segment may then scan the page, and automatically determines if any products are referenced on the page and can insert complete e-commerce functionality related to those products. Thus the website operator is advantageously able to insert the e-commerce capability for any product referenced on any page of his website with the insertion of a straightforward code segment. As new product references are added, and old references deleted, the code segment automatically adjusts to provide the e-commerce capability for new references, and removes the capability for old references. All of this is done with no additional effort on the part of the 3rd party website operator.

In yet another embodiment, the e-commerce system may provide an API accessible by a 3rd party website operator, which can be referred to as a server side API. The 3rd party web server may provide the e-commerce system with information identifying a product through the API, prior to sending a web page to a user. The 3rd party website may then receive information related to the product, such as current pricing information, from the e-commerce system. The 3rd party website may then integrate this information, as well as the all of the other e-commerce capabilities described in this disclosure, directly into the web page, prior to sending the web page to the user's browser. Interactions between the user and the e-commerce capability will then pass through the 3rd party website, as opposed to a direct interaction between the browser on the user's computer and the e-commerce system.

For example, the 3rd party website may display a product that has a UPC. The 3rd party website server may send the UPC to the e-commerce system's API. The e-commerce system may then return the information related to the product, such as current price, to the 3rd party web server. The third party web server may then insert the atomized e-commerce capability onto the web page. For example, the 3rd party website may provide the buy and sell buttons integrated with the web page sent to the user's browser, as opposed to those components being produced by a code segment inserted onto the web page. The 3rd party web server can utilize the API to receive updated information, such as pricing information, from the e-commerce system. The updated information is then sent from the 3rd party web server to the user's browser. In such an embodiment, the user's web browser is relieved of having to communicate with the e-commerce system to obtain the latest pricing information, while at the same time allowing the operator of the 3rd party website greater control over which items are available through the 3rd party website via the e-commerce system.

Furthermore, the 3rd party website operator is advantageously able to more closely integrate the e-commerce capability within his website. For example, embodiments of the invention described above may use a commerce window when a user wishes to engage in a transaction. Although the user's browser does not need to navigate away from the 3rd party website, the commerce window is still a separate window. Embodiments of the invention that utilize the server side API are able to integrate the functionality provided by the commerce window into the 3rd party web page itself. If a user should click on the buy or sell button, the 3rd party web server can communicate with the e-commerce system to relay transaction based information between the user and the e-commerce system. However, the presentation of that information is fully under the control of the 3rd party website operator. In essence, the functionality of the commerce window is still provided by the e-commerce system, however the presentation of that functionality is left to the 3rd party website operator. The 3rd party website operator may choose to present the information in the form of a standalone commerce window or may integrate the functionality within the web page.

In yet another embodiment, the ability to atomize e-commerce is completely divorced from the 3rd party website. A browser plug-in may be downloaded by a user and installed within his browser. The plug-in may scan any documents viewed by the user, both online and offline, and identify products that may be available for purchase or which the user might wish to sell. For example, similar to the code segment that scans a web page described above, the plug-in could scan the web page and identify products by UPC, ISBN, product title, or free text. The plug-in, through the user's browser, could open a communications channel with the e-commerce system to determine if e-commerce is available for any of the identified products. Just as above, for each item identified that has e-commerce available, the plug-in could associate an e-commerce capability. For example, the plug-in could turn any identified product reference into a link to the e-commerce system in the closed state. Upon activating the link, the user will be shown a commerce window, also referred to as the open state, in which he may purchase the product or list the product for sale through the e-commerce system, without leaving the web page that is currently being viewed.

In yet another embodiment, rather than using a browser side plug-in, a 3rd party website operator may install an application that has similar functionality to the browser plug-in on a website. The application may scan the pages of the website prior to sending the page to the user's browser. For any products identified, the application may communicate with the e-commerce system through the API described above to determine if e-commerce is available for the identified product. If e-commerce is available, the reference to the product could be turned into a link in the closed state, prior to sending the page to the user's browser. Such an embodiment advantageously allows the 3rd party website operator to be relieved of the burden of inserting the code segment on each page of his website, while at the same time automatically allowing for e-commerce to be conducted on any product reference on the website. The automated software may identify items that can be bought and sold without any intervention by the 3rd party website operator. The e-commerce functionality can then be provided to the user as described in the embodiments above.

In some embodiments, the application may automatically identify products available for e-commerce. The identified products may then be presented to the website operator for selection of products for which e-commerce is enabled. Such a hybrid approach allows for automatic identification of products, while at the same time giving the website operator control in enabling e-commerce for those identified products. Again, once the products are identified, the e-commerce functionality can then be provided to the user as described in the embodiments above.

FIG. 2 depicts the e-commerce buy capability in the open state. As described above, the e-commerce capability 108 may be included on a web page. A user may activate the e-commerce buy capability, for example, by clicking on the buy button 110. The result will be that the e-commerce capability will then enter the open state, as depicted by commerce window 112. The code segment that was inserted as described above may open commerce window 112, which may be, for example, an iframe. As mentioned above, in some embodiments, such as the server side API embodiment, the commerce window may not appear as a separate window, but rather is integrated by the 3rd party web server directly into the web page. For the remainder of the disclosure, the commerce window will be described as a separate window, however it should be understood that this is for simplicity of explanation. The functionality provided by the commerce window could also be integrated within the web page.

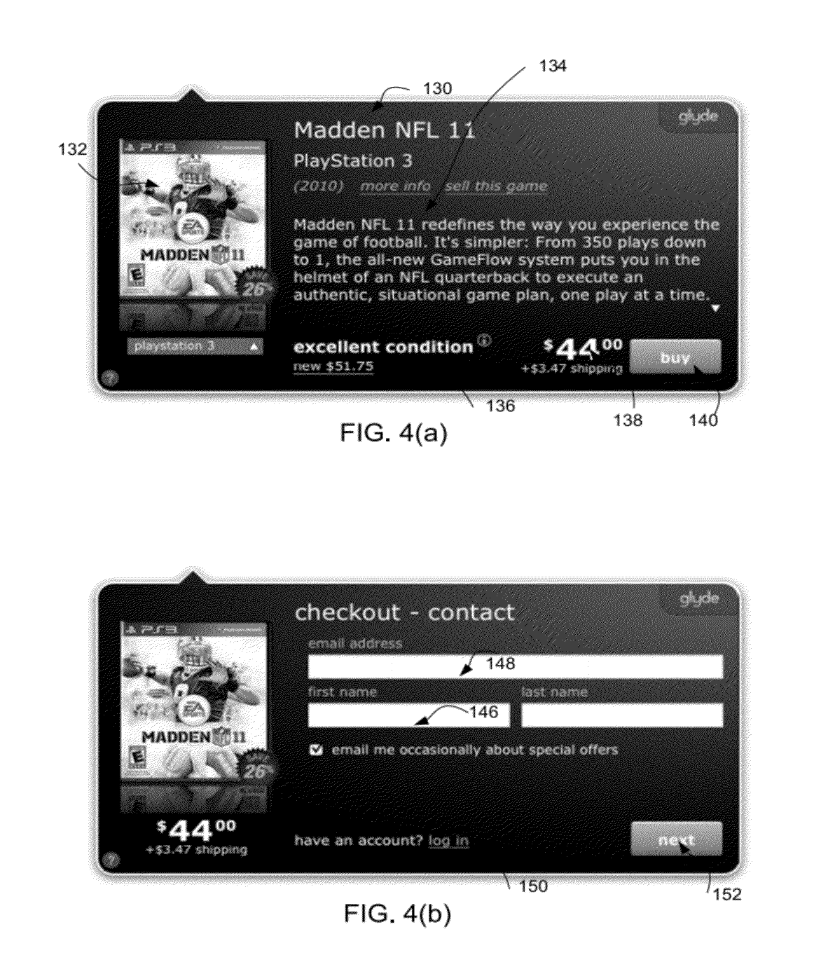

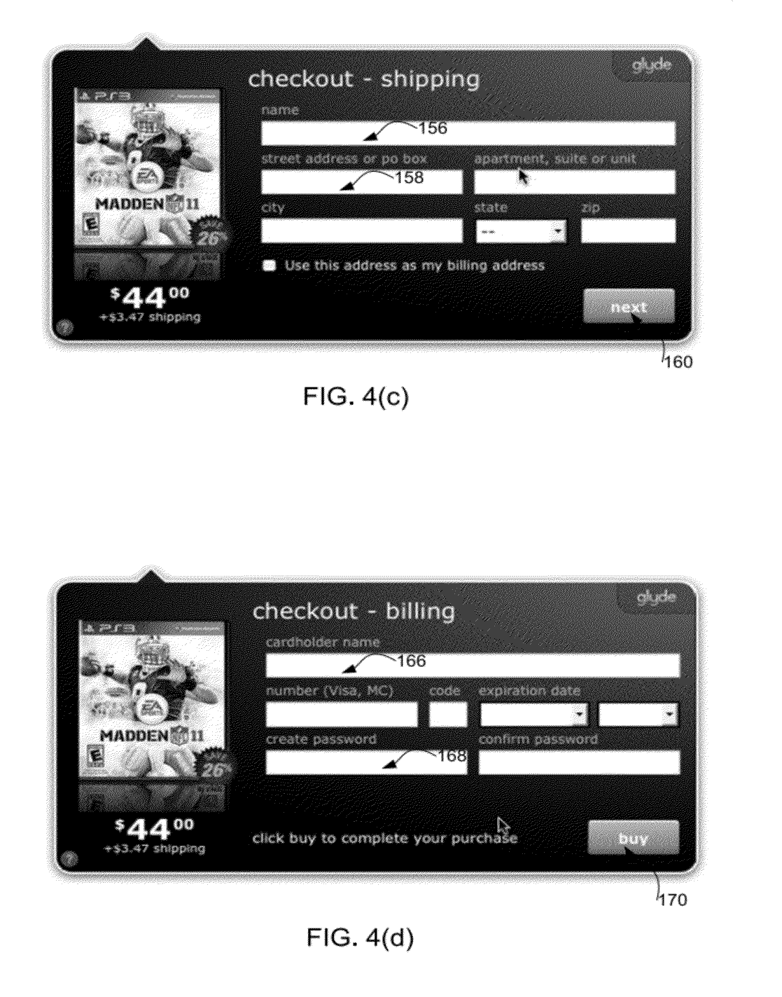

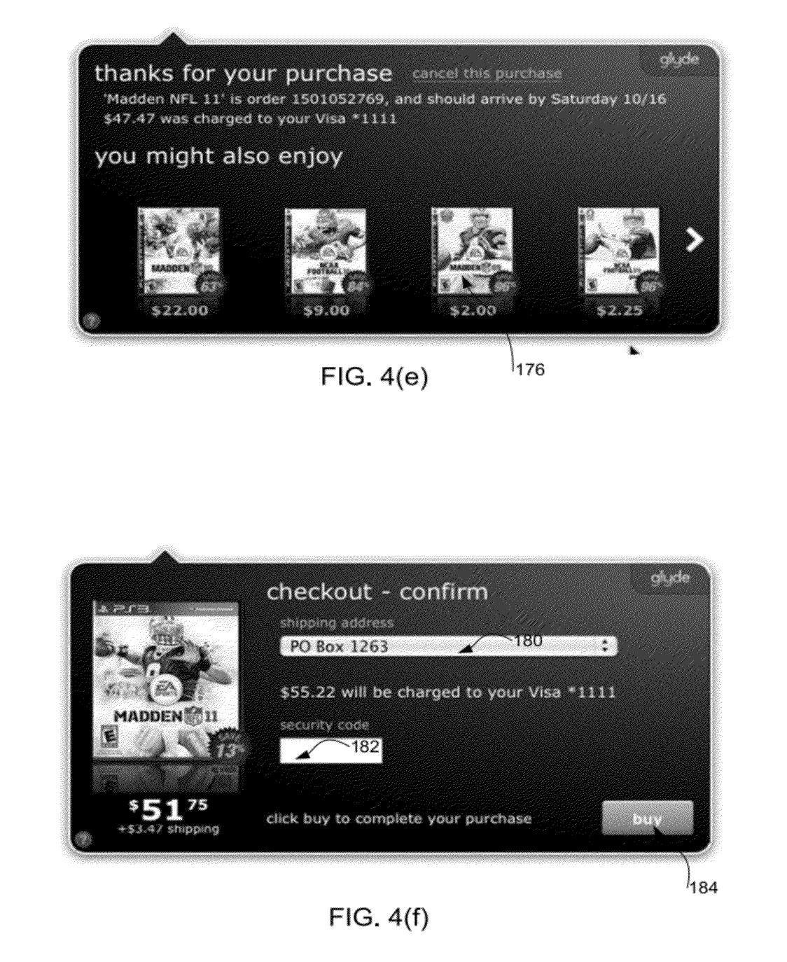

The code segment may then communicate with the e-commerce system to obtain current pricing information 114, item description 116, a picture of the item 118, or any other information desired. The user may then review the purchase information, and if desired click the buy button 120 to purchase the item. The purchase process will be described in further detail with respect to FIGS. 4(a-f).

What should be understood is that from the user's perspective, commerce window 112 simply appears on top of the 3rd party website. The user is unaware that the content within the commerce window 112 is actually coming from the e-commerce system. Thus, to the user, the product buying experience is seamless. The user can go from reviewing product information on a 3rd party website directly to a purchase or sell transaction, without having to leave the 3rd party website. This capability is advantageous to the user, as it simplifies the purchasing or selling process because the user is able to stay on the current website, without needing to be redirected to the e-commerce system's website. The third party website operator is advantageously able to offer the capability of buying a product referenced on the website without having to invest in developing an e-commerce system. The 3rd party website operator simply inserts a code segment (or uses one of the other embodiments described above) on his website.

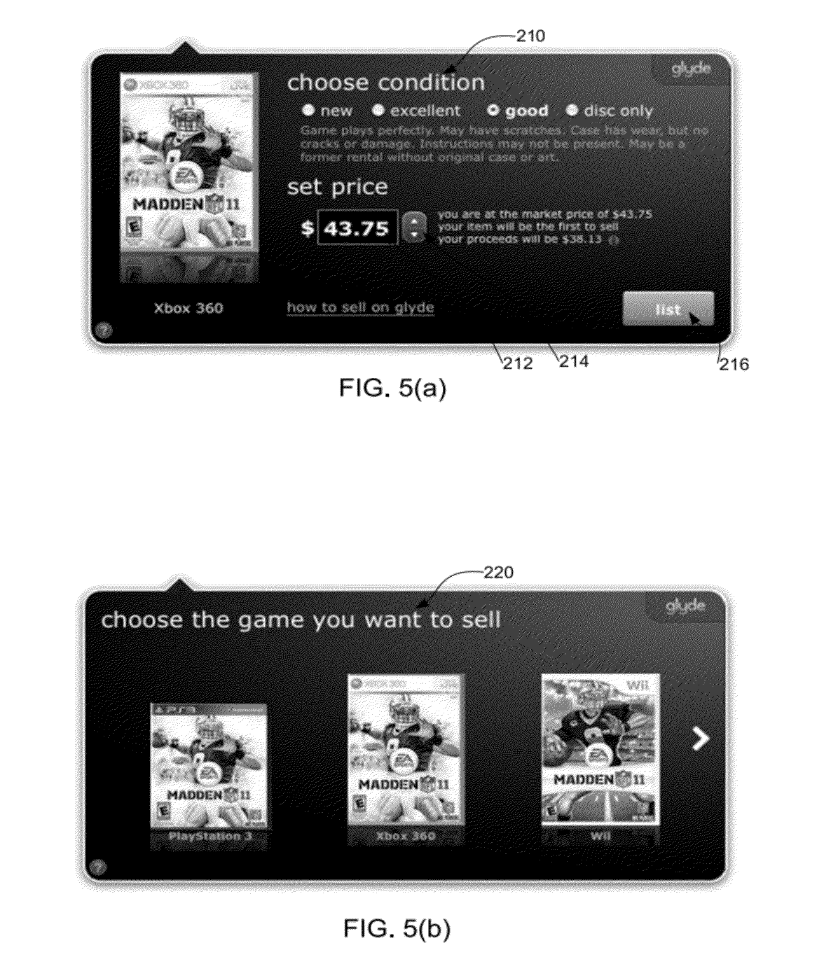

FIG. 3 depicts the e-commerce sell capability in the open state. Just as with the buy capability, the user may activate the e-commerce sell capability, for example, by clicking on the sell button 122. The result will be that the e-commerce capability will then enter the open state, as depicted again by commerce window 112. The e-commerce system may then ask the user to enter the condition 124 of the item that is being sold. Based on the condition specified by the user, the commerce window 112 may communicate with the e-commerce system to provide a suggested selling price 126 based on the current market demand on the e-commerce system. The e-commerce system may analyze the current market conditions for the item being offered for sale, and determine what the current, real time market price for the item is. The user may optionally be given the opportunity to adjust the listing price, up or down, from the suggested listing price. Once the user is satisfied with the price, he can click the list 128 button to list the item for sale. The process of selling an item will be described in further detail with respect to FIGS. 5(a-c).

FIGS. 4(a-f) depict screen shots of the various screens presented to a user who is purchasing a product using an embodiment of the present invention. Although the screen shots are depicted as standalone screens, it should be understood that the screens are actually displayed in commerce window 112 which appears over the 3rd party website. Thus, to the user, it appears like he has never left the 3rd party website.

FIG. 4(a) depicts a buy window that is similar to the one shown in FIG. 2. The title 130 of the product being purchased is displayed, along with an image of the product 132, a description of the product 134, the condition of the product 136, the price of the product 138, and a buy button to initiate the purchase transaction 140. As should be clear, all of the information shown in the screenshot of FIG. 4(a) is provided by the e-commerce system. The operator of the 3rd party website does not need to expend any additional effort, other than inserting the code segment onto pages of his website, in order to enable e-commerce on the 3rd party website.

FIG. 4(b) depicts a window that may be displayed after the user clicks the buy button 140 to purchase the item. If the user has not previously used the e-commerce system, the user is presented with a screen where he can register with the e-commerce system. The user may provide contact information, such as a name 146 and e-mail address 148. If the user has previously used the e-commerce system, the user is given the opportunity to enter his login information 150, in order to bypass the next several screens. Once the user has entered the necessary identification information, he may click on the next button 152 to proceed.

FIG. 4(c) depicts a screen wherein the user enters his shipping information. This can include his name 156 and address 158. The user can then click on the next button 160 to proceed to the next screen. FIG. 4(d) depicts a screen where the user can enter his billing information, such as credit card information 166. The user may also be able to select a password for future use of the e-commerce system 168. After the user has finished entry of the required information, he may select the buy button 170 to proceed to the next screen.

FIG. 4(e) depicts a confirmation screen which thanks the user for his purchase. In some embodiments, the user may also be presented with additional items 176 that may also be of interest to the user, based on his purchase. For example, a purchase of one type of video game may suggest other video games that are in the same genre of the purchased game.

FIGS. 4(b-d) are described with respect to a user that has never before used the e-commerce system. However, once a user is registered with the e-commerce system, the system is able to remember the user. For example, the e-commerce system may place a cookie on the user's machine, such that the user is automatically identified by the e-commerce system on subsequent visits. FIG. 4(f) depicts a screen that may be displayed to a previously registered user. The user's currently registered address 180 is shown. The user is also able to provide a security code 182, which is defined as part of the credit card purchase process, to ensure that the actual registered user is conducting the buy transaction. The user then may select the buy 184 button, and is taken to a purchase confirmation screen similar to that depicted in FIG. 4(e).

In cases where the user is previously registered, embodiments of the invention not only provide the ability to push e-commerce out onto every website, but also improve the users experience by providing a single page buy. For example, the user may be viewing a 3rd party website that includes an embodiment of the invention, and see a link in the closed state for an item of interest. The user then clicks on the buy button, and the commerce window 112 is displayed. Because the user is already registered, he can simply click the buy button. All information necessary to send the product to the user is already known by the e-commerce system. Thus, the user is advantageously able to complete a purchase transaction within a single web page displayed in the commerce window 112. Furthermore, the same streamlined single web page buy capability also extends to sell transactions. A previously registered user may click on a link in the closed state that is associated with an item the user owns and desires to sell. Because the user has previously registered, all information necessary to list the product for sale is already known. The user can list his product for sale simply by clicking a sell button, thus providing for a single page sell capability.

FIGS. 5(a-c) depict screen shots of the various screens presented to a user who is selling a product using an embodiment of the present invention. Again, just as above, the screens depicted in FIGS. 5(a-c) are actually displayed within a window 112 which appears on the 3rd party website. From the perspective of the user, he is not leaving the 3rd party website. For purposes of simplicity, the description of FIG. 5 assumes that the user is already registered with the e-commerce system. Although if the user is not registered with the e-commerce system, a registration process similar to that described with reference to FIGS. 4(b-d) may be performed.

FIG. 5(a) depicts a sell window that is similar to the one shown in FIG. 3. A user may select the condition 210 of the item being sold. Based on this condition, the e-commerce system may suggest a price 212 at which to list the item. The e-commerce system may arrive at this suggested price based on market factors such as the number of items of that condition that are being offered for sale, recent sales prices, or any number of additional market driven information. The user is then given the opportunity to adjust the price 214, either up or down, if he so desires. Once the user is satisfied with the selected price, he may click the list button 216 to list his item for sale on the e-commerce system. As should be clear, because the item is now for sale on the e-commerce system, other users who click the buy button as described above with reference to FIG. 2 may now have the opportunity to purchase the newly listed item.

In some cases, the user may need to specify the particular item that is being sold with greater detail. For example, in the case of a video game review 3rd party website, the reviews will generally describe the game in a platform independent format. Thus, when the user clicks on the sell button in the closed state to sell the described video game, it is necessary for the user to provide further information regarding which specific platform the game operates on. As shown in FIG. 5(b), if the e-commerce system is unable to determine the exact product that is being sold, further information can be requested from the user. The user may select the specific product 220 that is being sold. It should be noted that this same capability exists for a buy transaction. If the e-commerce system is unable to determine the product desired, the user can be prompted for further information.

FIG. 5(c) depicts a sell confirmation window that informs the user that his item is now listed for sale. When the item is sold, either on the e-commerce system operating in a stand alone fashion, or in accordance to embodiments of the present invention, the user is sent information on the next step. For example, as depicted in FIG. 5(c), in some embodiments the user may be informed 250 that once his item sells he will receive an e-mail and a pre-addressed mailer in which to insert the item. The preaddressed mailer may be addressed to the person who purchased the item. The user then simply inserts the product in the mailer and mails it. At some point, for example after the buyer has indicated he received the product, the user's account on the e-commerce system can be updated with the proceeds of the sale.

Although FIGS. 4 and 5 depict what seems like known e-commerce, what should be understood is that all of the steps for both buying and selling occur within either a secure window, such as an iframe on a 3rd party website or within an e-commerce capability that is integrated within the 3rd party website. A website operator that previously had no e-commerce capabilities can advantageously insert such capabilities onto his website with minimal effort. Unlike other systems, in which the user is directed away from the third party website to an external e-commerce system, embodiments of the present invention advantageously appear to the end user as if all transactions are being conducted on the initially visited 3rd party site, either through the commerce window or direct integration with the website. The user is made to feel more secure in that he may trust the 3rd party website that he is visiting, and may feel more comfortable conducting a transaction in an environment that appears to be related to that 3rd party website, as opposed to being redirected to an external e-commerce system.

Furthermore, the ability to sell products anywhere the product is referenced is advantageously provided. In prior systems, a user wishing to sell a product online would need to either set up his own e-commerce system or go to a website, such as eBay, that is dedicated to selling products. Embodiments of the present invention advantageously push the ability to list a product for sale onto any website, including those not related to e-commerce. For example, a user may be reading a blog post that references a certain item that the user owns. Embodiments of the invention could turn the reference into a link, and the user could click that link to sell his item. Advantageously, the user did not have to leave the original blog site. Furthermore, adding the e-commerce capability to the blog site required minimal effort by the blog site owner. Just as advertisements are included on almost every web page to induce users to purchase products, embodiments of the present invention now provide the capability to sell products on vast numbers of web pages. Essentially every website that references a product can be turned into an opportunity for a user to sell that product.

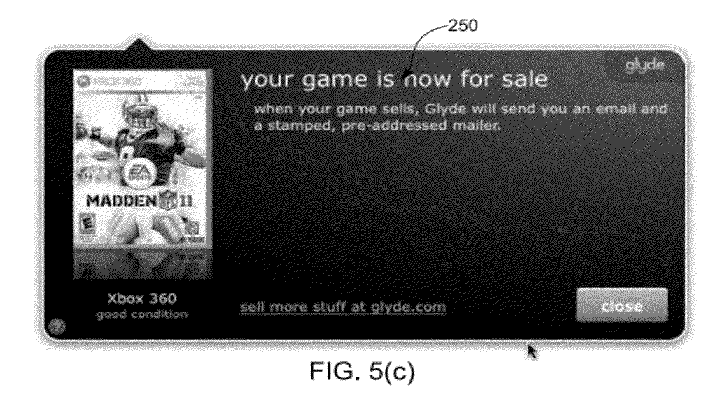

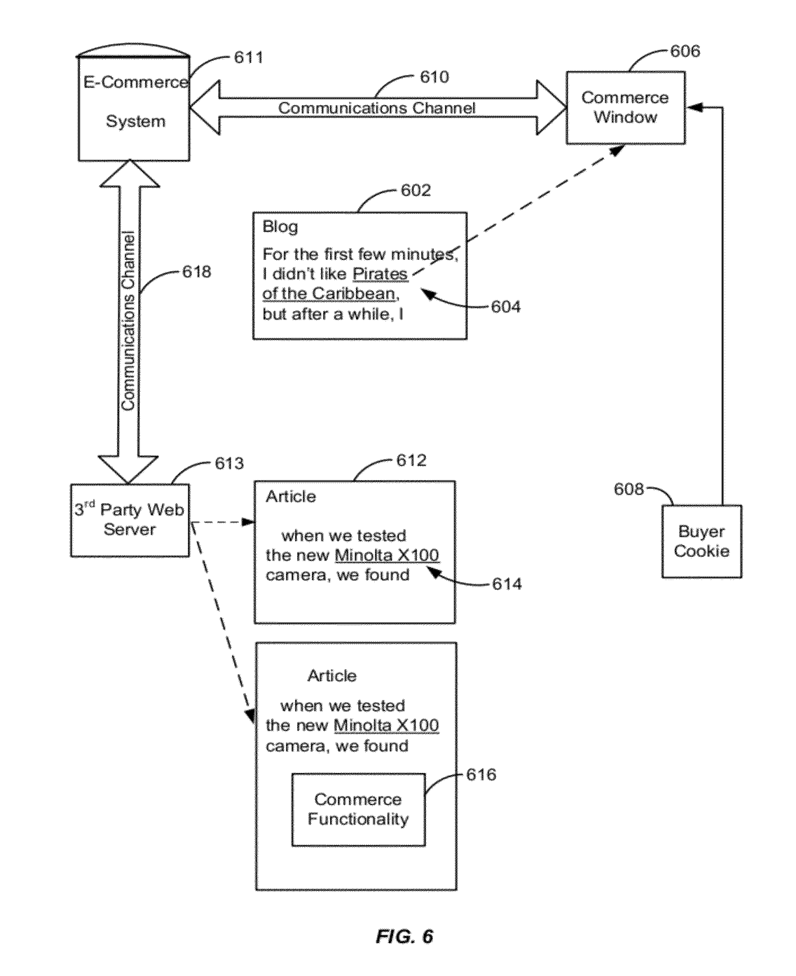

FIG. 6 illustrates one embodiment of how commerce can be atomized. The e-commerce capability is pushed out everywhere on the Internet, but the user experience is one of all or most of the buy or sell capability being on the 3rd party website itself. FIG. 6 shows an example of a blog 602 mentioning a movie 604 available on DVD.

The blog author may utilize any of the embodiments described above in order to turn the product reference into a link in the closed state. For example, as a blog entry is typically a free flowing text narrative, the blog author may have inserted the code segment that scans a web page into his blog post. When the blog post is loaded by a user's web browser, the code segment will scan the web page and determine if e-commerce is available for any product references within the blog post. If e-commerce is available for the DVD title, the title can be turned into a link 604 in the closed state.

If a reader clicks (or hovers over) the link, a commerce window 606 is generated, as described above with respect to FIGS. 2 and 3. In some embodiments the functionality of the commerce window may be integrated within the initial web page, which will be described below. If the user is already registered with the system, the user may be identified by a cookie 608 on the user's computer. A communications channel 610 may be opened by the code segment to retrieve the product information including current market price from e-commerce system 611.

As described above, a registered user conducting a buy or sell transaction can conduct the transaction within a single page in the commerce window. For example, in a buy transaction, the user clicks the buy button in the commerce window and the purchase is essentially complete. From the user's perspective, it appears as if the purchase is completed on the blog site, even though the transaction is conducted through the e-commerce system.

If the user isn't registered, when the user clicks the link in the closed state 604, the commerce window may appear and prompt the user to login or register as described with reference to FIGS. 4(a-f). Although multiple pages may be required to complete the transaction, all of the pages will be displayed within the commerce window 606. Thus, the user is able to register on the e-commerce site and complete a purchase or sale, all while appearing to have stayed on the blog website.

Window 612 of FIG. 6 is another example of the atomization of commerce. A 3rd party web server 613 may utilize the server side API to provide the e-commerce capability to a web page. For example, the 3rd party website may produce a web page containing an article 612. Prior to sending the web page to a user's browser, the 3rd party website 613 may identify specific products or scan the web page using an application to identify products, as described above. The 3rd party website 613 may use the API and establish a communications channel 618 with the e-commerce system 611 to determine if e-commerce is available for the identified products. If so, a closed state link 614 may be inserted into the article 612. This embodiment is different from that described above, because the closed state link is integrated within the web page 612 that is sent to the user, as opposed to being produced by a code segment inserted into the web page, which then runs on the user's browser.

If the user clicks the link in the closed state 614, rather than opening a separate commerce window, the activation of the link is communicated back to the 3rd party web server. The capabilities that are provided within the commerce window can then be provided to the 3rd party web server 613, through the API. The third party web server may then present the e-commerce capabilities to the user as commerce functionality 616 that is integrated within the web page provided by the 3rd party web server.

Although FIG. 6 has been described with reference to buying a product, it should be understood that embodiments of the invention are not limited to purchase transactions. Anyplace that the opportunity to insert atomized e-commerce for a buy transaction is present, the same opportunity also exists for inserting a sell transaction. Thus as described above, in the blog entry where a product is discussed, the link may not be limited to purchasing the product, but could also include allowing the user to list that particular product for sale.

System

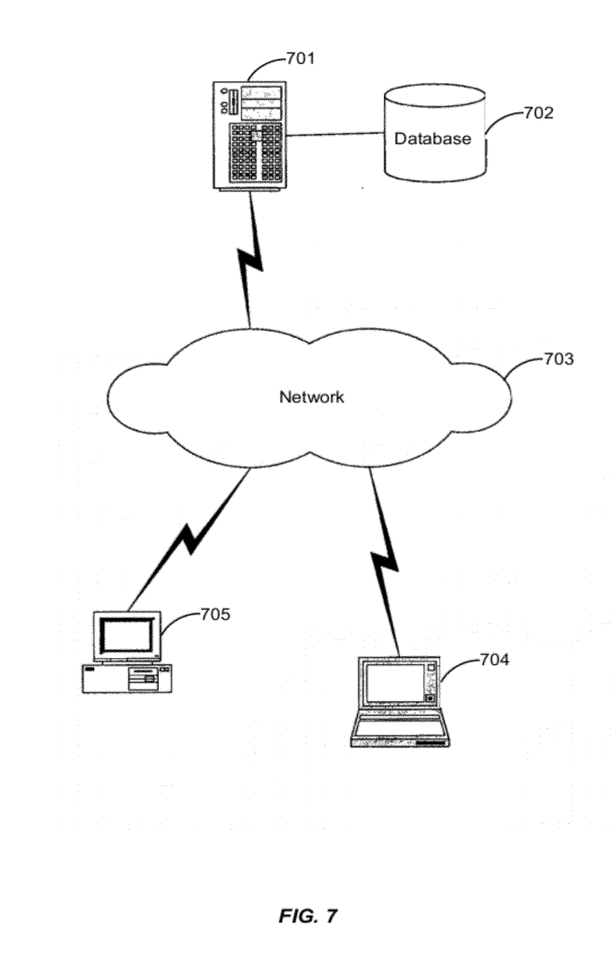

FIG. 7 illustrates a system supporting the present invention. A server 701 hosting the e-commerce system is connected to a network 703 (e.g., the Internet). Also connected to the Internet is a 3rd party website 704 which may display content which includes references to products on the e-commerce system. Finally, a user computer 705 is shown connected to the Internet, for browsing either the e-commerce system or 3rd party website.

The server 701 is configured to provide the commerce window 112 with a display of a product and react to user actions. The server 701 may be implemented using multiple computing devices. A database 702 stores data on sellers, users, and products. In one embodiment, database 702 is directly connected to server 701. In another embodiment, database 702 includes multiple storage devices that are accessible over network 703 or another network.

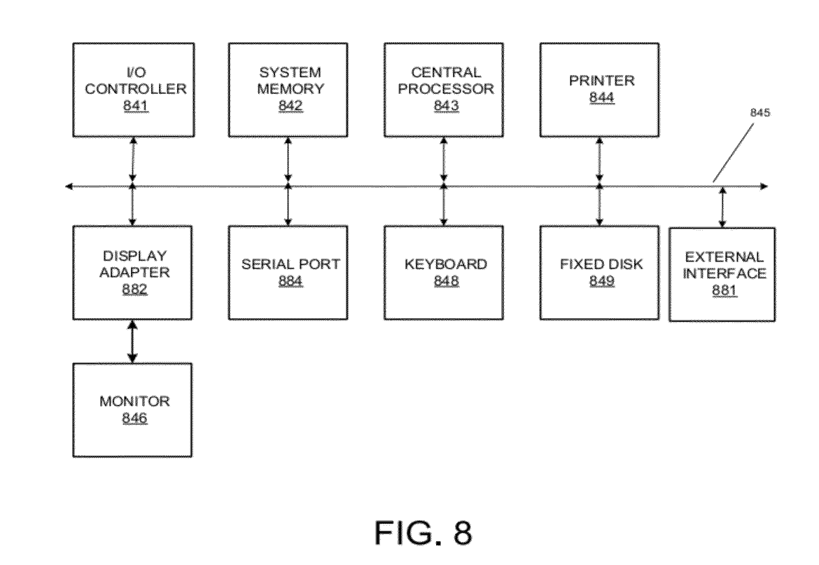

FIG. 8 is a high level block diagram of a computer system that may be used to implement any of the entities or components (e.g., the 3rd party web server, e-commerce system, or user computer, etc.) described above and may include one or more of the subsystems or components shown in FIG. 8, which is a block diagram of a computer apparatus. The subsystems shown in FIG. 8 are interconnected via a system bus 845. Additional subsystems such as a printer 844, keyboard 848, fixed disk 849, monitor 846, which is coupled to display adapter 882, and others are shown. Peripherals and input/output (I/O) devices, which couple to I/O controller 841, can be connected to the computer system by any number of means known in the art, such as serial port 884. For example, serial port 884 or external interface 881 can be used to connect the computer apparatus to a wide area network such as the Internet, a mouse input device, or a scanner. The interconnection via system bus allows the central processor 843 to communicate with each subsystem and to control the execution of instructions from system memory 842 or the fixed disk 849, as well as the exchange of information between subsystems. The system memory 842 and/or the fixed disk 849 may embody a computer readable medium.

Any of the software components or functions described in this application, may be implemented as software code to be executed by a processor using any suitable computer language such as, for example, Java, Javascript, HTML, C, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

It is to be understood that the examples and embodiments described above are for illustrative purposes only and that various modifications or changes in light thereof will be suggested to persons skilled in the art and are to be included within the spirit and purview of this application and scope of the appended claims. For example, the links ads could be placed in video games, such as an image of a DVD on a shelf in a virtual room being linked to a single page buy when clicked. For another example, the products can be DVDs, CDs, video games, books, consumer electronics (i.e., PDAs, cell phones, etc.), jewelry, toys, software or any other product or service. The product or service can be bought, bartered for or rented. The embodiments can be applied to single or multi-vendor e-commerce systems, and the vendors can be individuals, large corporations, small businesses, charities or any other organization. As used in the claims, the term “products” includes services. Furthermore, the term “products” can also include digital goods, including video files, audio files, and other digital goods. Although described in terms of a computer, embodiments of the invention are applicable in any web environment, including mobile web environments. Therefore, the above description should not be understood as limiting the scope of the invention as defined by the claims.

What is claimed is:

1. A software method comprising:
identifying a product on a web page;
creating a closed state link to the product on the web page with a computer, the closed state link indicating the product is available for e-commerce; and
creating an open state commerce window when the closed state link is activated by a user using a web browser, the open state commerce window comprising a transaction window wherein a transaction related to the product can be conducted by the user within the transaction window without navigating the web browser away from the web page.

2. The method of claim 1, wherein the transaction is a sell transaction.

3. The method of claim 1, wherein creating a closed state link to the product includes inserting a code segment onto the web page, the code segment causing the web browser to communicate with an e-commerce system to retrieve data related to the product.

4. The method of claim 1, wherein identifying the product on the web page includes inserting a code segment on the web page that scans the web page for products available for e-commerce.

5. The method of claim 1, wherein identifying the product on the web page includes installing a plug-in within the web browser that scans any page viewed by the web browser for products available for e-commerce.

6. The method of claim 1, wherein identifying the product on the web page includes installing an application on a web server that scans the web page for products available for e-commerce prior to sending the web page to the web browser.

7. The method of claim 1, wherein identifying the product on the web page includes manually identifying the product and inserting a code segment related to the product on the web page.

8. The method of claim 1 wherein activating the closed state link comprises hovering over the closed state link.

9. The method of claim 1, wherein the commerce window is an iframe.

10. The method of claim 1, wherein the closed state link is at least one of an image, text, a buy button, or a sell button.

11. The method of claim 3, wherein the closed state link displays the current price for the product on the e-commerce system.

12. The method of claim 3 wherein the code segment includes JavaScript code that allows the web page to communicate with the e-commerce system.

13. The method of claim 1, wherein the transaction is a single page buy transaction.

14. A software method comprising:
identifying a product on a web page;
creating a link to the product on the web page with a computer, the link indicating the product is available for e-commerce; and
upon activation of the link by a user using a web browser, presenting the user with a commerce window wherein the user may list the product for sale within the commerce window without navigating the web browser away from the web page.

15. The method of claim 14, wherein creating a link to the product includes inserting a code segment onto the web page, the code segment causing the web browser to communicate with an e-commerce system to retrieve data related to the product.

16. The method of claim 14, wherein identifying the product on the web page includes inserting a code segment on the web page that scans the web page for products available for e-commerce.

17. The method of claim 14, wherein identifying the product on the web page includes installing a plug-in within the web browser that scans any page viewed by the web browser for products available for e-commerce.

18. The method of claim 14, wherein the commerce window is an iframe.

19. The method of claim 15 wherein the code segment includes JavaScript code that allows the web page to communicate with the e-commerce system.

20. A software method comprising:
identifying a product, with a web server computer, on a web page prior to sending the web page to a user's browser;
accessing an application programming interface of an e-commerce system to determine if e-commerce is available for the identified product;
creating a closed state link to the product on the web page, if e-commerce is available for the product;
sending the web page to the user's web browser; and
providing e-commerce capabilities integrated within the web page when the closed state link is activated by a user using a web browser, the e-commerce capabilities including the ability to conduct a transaction related to the product from within the web page.

21. The method of claim 20 wherein the product is identified by a website operator.

22. The method of claim 20 wherein an application running on the server computer identifies the product within the web page.

23. The method of claim 20, wherein the e-commerce capabilities related to the product are integrated within the web page provided by the web server.
